(19) United States
(12) Patent Application Publication
(10) Pub. No.: US 2004/0037433 A1
(43) Pub. Date: Feb. 26, 2004

(54) Multi-channel wireless professional audio system

(76) Inventor: Heng-Chien Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,813

(22) Filed: Aug. 21, 2002

(51) Int. Cl. H04B 3/00; H04B 5/00

(52) U.S. Cl. 381/79; 381/77

(57) ABSTRACT

A multi-channel wireless audio system has a signal broadcasting circuit that includes a multiplexer having a plurality of input nodes and one output node, each input node being used to receive audio signals of an audio channel, the output node being used for outputting audio signals of a selected audio channel, an analog to digital converter for converting the audio signals of the selected audio channel into digital audio signals, and a first transceiver for wirelessly transmitting the digital audio signals to external speakers. The multi-channel wireless audio system also includes several wireless speaker modules, each including a second transceiver for receiving the wireless digital audio signals from the signal broadcasting circuit, a digital to analog converter for converting the digital audio signals into analog audio signals, an amplifier for amplifying the analog audio signals, and a speaker for converting the amplified analog audio signals into sound.

### BACKGROUND OF INVENTION

1. Field of the Invention

The present invention relates to a professional audio system, and more specifically, to a professional audio system that wirelessly transmits multi-channel signals to speakers.

2. Description of the Prior Art

In professional audio systems, a large number of audio channels can be used to output sounds for various input devices. For example, compact disc players output sound in stereo format, which uses two audio channels. The Dolby AC-3 standard outputs 5.1 channels, which includes 5 discrete audio channels plus a low frequency channel. In professional audio systems, 24 channel audio systems are commonly used, and each of the audio channels can be sent to a unique speaker for output. In a traditional 24 channel professional audio system, audio processing circuitry is connected to up to 24 speakers through a cable going from the audio processing circuitry to each speaker.

Please refer to FIG. 1. FIG. 1 is a block diagram of a wired professional audio system according to the prior art. Audio processing circuitry 12 is connected to a plurality of speakers 14, which are positioned in various locations around a room. For example, FIG. 1 shows eight speakers 14 that could be used in a surround sound setting: a front left speaker, a median speaker, a super woofer, a front right speaker, a middle right speaker, a rear right speaker, a rear left speaker, and a middle left speaker. These speakers 14 are stated as an example only, and any number of speakers 14 can be used. Typically, one speaker 14 is used for each channel provided by the wired professional audio system 10.

Please refer to FIG. 2. FIG. 2 is a functional block diagram of the wired professional audio system 10. The audio processing circuitry 12 contains an audio channel generator 20 and a set of high power amplifiers 26. The audio channel generator 20 contains a sound source 21 for receiving audio signals from sources such as a microphone, a compact disc player, or a digital video recorder. The sound source 21 then sends audio signals to a preamplifier and mixer 22, and then to an equalizer and special effects generator 25. At this stage, the audio channel generator 20 has divided the audio signals into distinct audio channels (such as 24 channels). These audio channel signals are then sent to the high power amplifiers 26, where each audio channel is amplified. Finally, the audio processing circuitry 12 sends each audio channel to a unique speaker 14.

Unfortunately, not only does the setup for the wired professional audio system 10 require a large number or cables connected to the audio processing circuitry 12, but it also makes positioning the speakers 14 much more troublesome. Care has to be taken to make sure speaker cables are positioned out of the way to allow easy movement around the wired professional audio system 10. Moreover, if one of the speakers 14 is to be moved, care must be taken to ensure that the corresponding speaker cable is long enough to reach the new location of the speaker 14. In addition, speaker cables used in professional audio systems are very expensive, and can be 30 to 100 meters long. Moreover, speaker cables have to be carefully designed so that audio output is not affected by RLC characteristics of the cables. For example, suppose that a speaker has a power rating of 1000W with a resistance of 8 Ω. That means that the speaker cable leading to each speaker would have a high amount of current being carried through it. Since the frequency response for the speaker is desired to be above 20 kHz, that means that the total resistance of the speaker cable (including the two ends) has to be less than 1 Ω. Unfortunately, undesirable RLC effects of the speaker cable can affect the quality of the audio output, and adversely affect the frequency response.

### SUMMARY OF INVENTION

It is therefore a primary objective of the claimed invention to provide a multi-channel wireless audio system in order to solve the above-mentioned problems. According to the claimed invention, a multi-channel wireless audio system has a signal broadcasting circuit. The signal broadcasting circuit includes a multiplexer having a plurality of input nodes and one output node, each input node being used to receive audio signals of an audio channel, the output node being used for outputting audio signals of a selected audio channel, an analog to digital converter for converting the audio signals of the selected audio channel into digital audio signals, and a first transceiver for wirelessly transmitting the digital audio signals to external speakers. The multi-channel wireless audio system also includes several wireless speaker modules, each including a second transceiver for receiving the wireless digital audio signals from the signal broadcasting circuit, a digital to analog converter-for converting the digital audio signals into analog audio signals, an amplifier for amplifying the analog audio signals, and a speaker for converting the amplified analog audio signals into sound.

It is an advantage of the claimed invention that the multi-channel wireless audio system does not need speaker cables to connect speakers to the signal broadcasting circuit. This makes positioning the speakers much easier, and no speaker cables have to be hidden out of the way. Speakers can easily be moved to new positions without worrying about the length of speaker cables. Additionally, wirelessly broadcasting digital signals eliminates the need for expensive speaker cables that can adversely affect audio output characteristics, and wireless transmission does not lead to audio quality degradation.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a wired professional audio system according to the prior art.

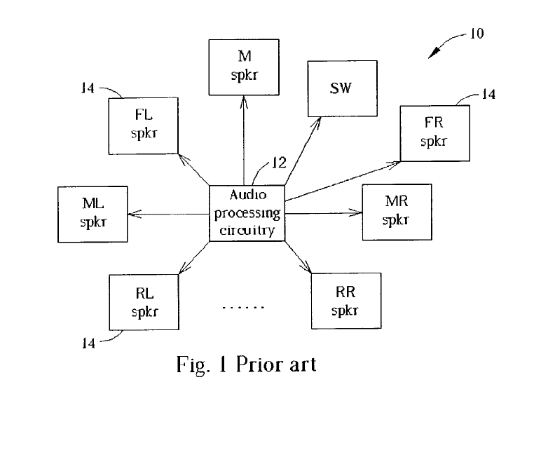

FIG. 2 is a functional block diagram of the wired professional audio system.

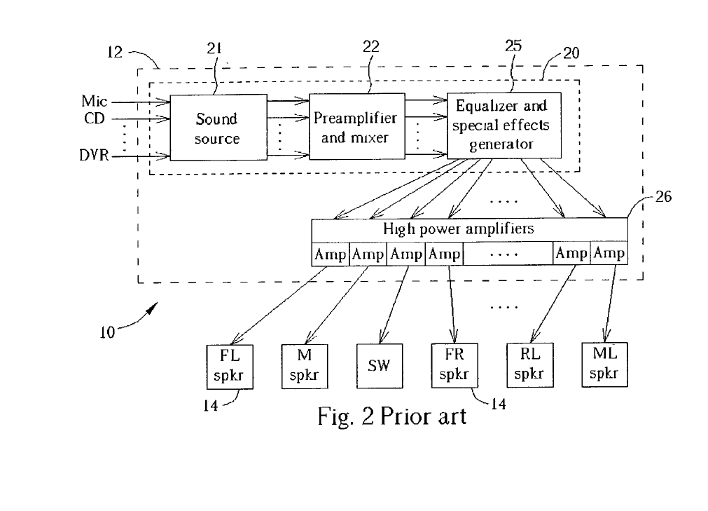

FIG. 3 is a block diagram of a wireless professional audio system according to the prior art.

FIG. 4 is a functional block diagram of a signal broadcasting circuit of the wireless professional audio system.

FIG. 5 is a functional block diagram of a single channel speaker module used in the wireless professional audio system.

FIG. 6 is a functional block diagram of a multi-channel speaker module used in the wireless professional audio system.

### DETAILED DESCRIPTION

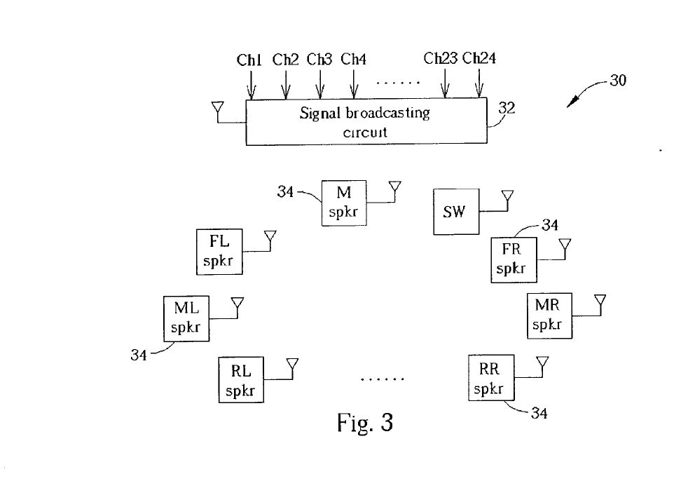

Please refer to FIG. 3. FIG. 3 is a block diagram of a wireless professional audio system 30 according to the present invention. A signal broadcasting circuit 32 is used to wirelessly send multiple audio channels to corresponding speaker modules 34. As with the example described in the prior art, the following description will assume that the wireless professional audio system 30 uses 24 audio channels and up to 24 speaker modules 34. Of course, the present invention can easily be extended to include any number of audio channels used in a professional audio system. The signal broadcasting circuit 32 receives audio signals from the 24 audio channels, and wirelessly broadcasts these audio signals to all speaker modules 34. As will be described later, each speaker module 34 only produces sound generated by the audio channel corresponding to that speaker module 34.

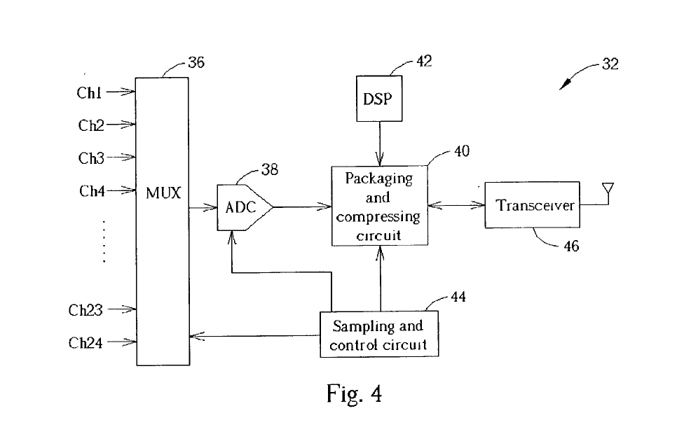

Please refer to FIG. 4. FIG. 4 is a functional block diagram of the signal broadcasting circuit 32 of the wireless professional audio system 30. Audio signals from each of the 24 audio channels are fed into a multiplexer 36. To minimize the complexity of the signal broadcasting circuit 32, the multiplexer is used to select one audio channel at a time for processing and transmission. A sampling and control circuit 44 is used to select one of the inputted audio channels to be outputted from the multiplexer 36.

Signals from the selected audio channel are then converted into digital signals via an analog-to-digital converter (ADC) 38. Operation of the ADC 38 is also controlled by the sampling and control circuit 44. Digital audio signals are then sent from the ADC 38 to a packaging and compressing circuit 40 so that the signals can be appropriately packaged and compressed for wireless transmission. A digital signal processor (DSP) 42 is used to aid the packaging and compressing circuit 40 with these functions, and the sampling and control circuit 44 helps to control operation of the packaging and compressing circuit 40. Finally, the packaging and compressing circuit 40 sends the digital signals to a transceiver 46 for wireless transmission to the speaker modules 34. During the packaging operation, a unique channel identifier is put into the packaged signals to denote which channel signal is being transmitted.

Although all speaker modules 34 will receive the transmitted wireless signal, only speaker modules 34 with this same channel identifier will produce sounds made by this channel. In order to broadcast signals for all 24 audio channels to the speaker modules 34, sampling and control circuit 44 will take turns selecting different audio channels to be output from the multiplexer 36. Moreover, the switching and transmission of each different audio channel is done quickly so that all 24 channels can be broadcast to all speaker modules 34 in real time. In this way, all audio channels can be wirelessly transmitted to all speakers in the wireless professional audio system 30.

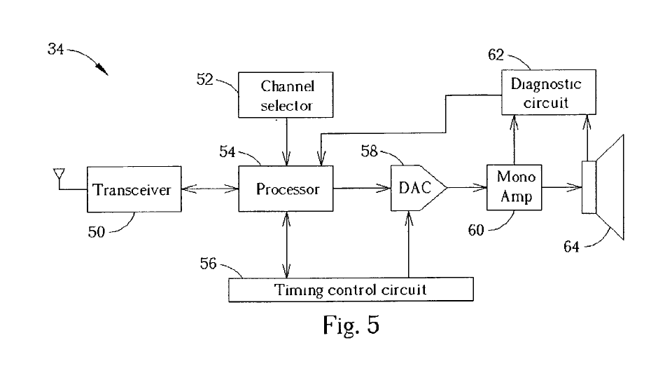

Please refer to FIG. 5. FIG. 5 is a functional block diagram of a single channel speaker module 34 used in the wireless professional audio system 30. The basic structure of each speaker module 34 in the wireless professional audio system 30 is identical, so FIG. 5 can be used to represent each of the speaker modules 34. A transceiver 50 is used to receive all wireless digital signals transmitted by the signal broadcasting circuit 32, and these signals are then sent to a processor 54 for appropriate processing. The processor 54 will then compare the channel identifier included in the received signals with a channel identifier stored in a channel selector 52. If the identifier does not match, the speaker module 34 does no further processing on the received signals. If there is a match, the received digital signals are then sent to a digital-to-analog converter (DAC) 58 for conversion back into analog signals. A timing control circuit 56 communicates with the processor 54, and helps control timing for operation of the processor 54 and the DAC 58. Analog signals produced by the DAC 58 are then sent to a mono amplifier 60 for amplification before being sent to a speaker 64 that converts the amplified analog signals into sound. A diagnostic circuit 62 is used to notify the processor 54 of any problems that are detected in the operation of the mono amplifier 60 and the speaker 64.

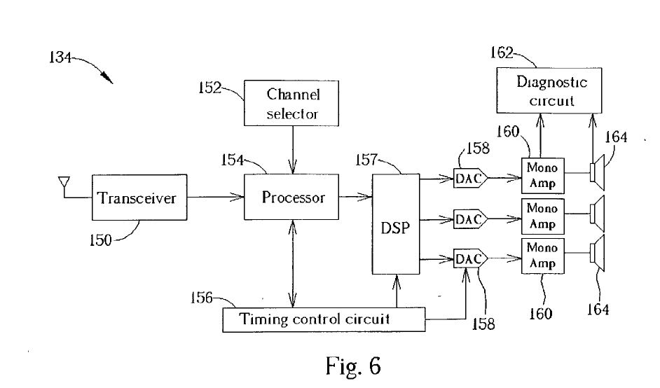

The speaker module 34 shown in FIG. 5 is a single channel speaker, meaning that it is only capable of playing sounds from one audio channel. Please refer to FIG. 6. FIG. 6 is a functional block diagram of a multi-channel speaker module 134 used in the wireless professional audio system 30. Operation of the multi-channel speaker module 134 is nearly identical to operation of the speaker module 34 shown in FIG. 5. The only difference is the addition of more channels to the speaker. As an example, the multi-channel speaker module 134 shown in FIG. 6 is a three-channel speaker, which produces low, medium, and high frequency sounds, but any number of channels could be used in the present invention.

A transceiver 150 is used to receive all wireless digital signals transmitted by the signal broadcasting circuit 32, and these signals are then sent to a processor 154 for processing. The processor 154 will then compare the channel identifier included in the received signals with a set of channel identifiers stored in a channel selector 152. If the identifier does not match, the multi-channel speaker module 134 does no further processing on the received signals. If there is a match, the received digital signals are then sent to a DSP 157 for signal processing. Based on the channel identifier included with the received signals, the DSP 157 then sends the signals to one of three digital-to-analog converters (DACs) 158 for conversion back into analog signals. A timing control circuit 156 communicates with the processor 154, and helps control timing for operation of the processor 154 and the DACs 158. Analog signals produced by each DAC 158 are then sent to a corresponding mono amplifier 160 for amplification before being sent to a corresponding speaker 164 that converts the amplified analog signals into sound. A diagnostic circuit 162 is used to notify the processor 154 of any problems that are detected in the operation of the mono amplifiers 160 and the speakers 164.

In a preferred embodiment of the present invention, all wireless signals transmitted by the transceiver of the signal broadcasting circuit and received by the transceiver of the speaker modules are direct sequence spread spectrum (DSSS) signals that conform to the IEEE 802.11b networking standard.

Compared to the prior art, the wireless professional audio system is able to send audio signals from the signal broadcasting circuit to speaker modules via wireless transmission, eliminating the need for speaker cables to connect a audio processing circuitry with speakers. Transceivers are used in both the signal broadcasting circuit and the speaker modules to facilitate the wireless communication. The flexibility that wireless transmission provides makes positioning the speakers much easier, and speakers can easily be moved to new positions without worrying about the constraint of speaker cables. Additionally, wirelessly broadcasting digital signals eliminates the need for expensive speaker cables that can adversely affect audio output characteristics, and wireless transmission does not lead to audio quality degradation.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-channel wireless audio system comprising:
a signal broadcasting circuit comprising:
a multiplexer having a plurality of input nodes and one output node, each input node being used to receive audio signals of an audio channel, the output node being used for outputting audio signals of a selected audio channel;
an analog to digital converter for converting the audio signals of the selected audio channel into digital audio signals; and
a first transceiver for wirelessly transmitting the digital audio signals to external speakers; and
a plurality of wireless speaker modules each comprising:
a second transceiver for receiving the wireless digital audio signals from the signal broadcasting circuit;
a digital to analog converter for converting the digital audio signals into analog audio signals;
an amplifier for amplifying the analog audio signals; and
a speaker for converting the amplified analog audio signals into sound.

2. The audio system of claim 1 wherein the signal broadcasting circuit further comprises a packaging and compressing circuit for compressing the digital audio signals outputted from the analog to digital converter and dividing the signals into packages before wireless transmission by the first transceiver.

3. The audio system of claim 2 wherein the signal broadcasting circuit further comprises a digital signal processor (DSP) for controlling operation of the packaging and compressing circuit.

4. The audio system of claim 1 wherein the signal broadcasting circuit further comprises a sampling and control circuit for controlling operation of the multiplexer and the analog to digital converter.

5. The audio system of claim 1 wherein each wireless speaker module further comprises a processor for controlling operation of the wireless speaker module.

6. The audio system of claim 5 wherein each wireless speaker module further comprises a channel selector for identifying a selected audio channel, and the processor of the wireless speaker module processes only those digital audio signals corresponding to the selected audio channel.

7. The audio system of claim 5 wherein each wireless speaker module further comprises a diagnostic circuit for detecting performance problems in the amplifier and the speaker, and for notifying the processor of any problems.

8. The audio system of claim 1 wherein each wireless speaker module further comprises a timing control circuit for controlling timing of the digital to analog converter.

9. The audio system of claim 1 wherein the wireless digital signals transmitted from the signal broadcasting circuit to the plurality of wireless speaker modules are direct sequence spread spectrum signals.

10. The audio system of claim 1 wherein the wireless digital signals transmitted from the signal broadcasting circuit to the plurality of wireless speaker modules conform to the IEEE 802.11b networking standard.

11. A multi-channel wireless audio system comprising:
a signal broadcasting circuit comprising:
a multiplexer having a plurality of input nodes and one output node, each input node being used to receive audio signals of an audio channel, the output node being used for outputting audio signals of a selected audio channel;
an analog to digital converter for converting the audio signals of the selected audio channel into digital audio signals; and
a first transceiver for wirelessly transmitting the digital audio signals to external speakers; and
at least one multi-channel wireless speaker module comprising:
a second transceiver for receiving the wireless digital audio signals from the signal broadcasting circuit;
a plurality of digital to analog converters for converting digital audio signals into analog audio signals;
a plurality of amplifiers for amplifying the analog audio signals; and
a plurality of speakers for converting the amplified analog audio signals into sound.

12. The audio system of claim 11 wherein the signal broadcasting circuit further comprises a packaging and compressing circuit for compressing the digital audio signals outputted from the analog to digital converter and dividing the signals into packages before wireless transmission by the first transceiver.

13. The audio system of claim 12 wherein the signal broadcasting circuit further comprises a first digital signal processor (DSP) for controlling operation of the packaging and compressing circuit.

14. The audio system of claim 11 wherein the signal broadcasting circuit further comprises a sampling and control circuit for controlling operation of the multiplexer and the analog to digital converter.

15. The audio system of claim 11 wherein each wireless speaker module further comprises a processor for controlling operation of the wireless speaker module.

16. The audio system of claim 15 wherein each wireless speaker module further comprises a channel selector for identifying a plurality of selected audio channels, and the processor of the wireless speaker module processes only those digital audio signals corresponding to the selected audio channels.

17. The audio system of claim 15 wherein each wireless speaker module further comprises a diagnostic circuit for detecting performance problems in the amplifiers and the speakers, and for notifying the processor of any problems.

18. The audio system of claim 11 wherein each wireless speaker module further comprises a timing control circuit for controlling timing of the digital to analog converters.

19. The audio system of claim 11 wherein the wireless digital signals transmitted from the signal broadcasting circuit to the plurality of wireless speaker modules are direct sequence spread spectrum signals and conform to the IEEE 802.11b networking standard.

20. A multi-channel wireless audio system comprising:
a signal broadcasting circuit comprising:
a plurality of analog to digital converters, each for converting audio signals of a selected audio channel into digital audio signals; and
a first transceiver for wirelessly transmitting the digital audio signals to external speakers; and
a plurality of wireless speaker modules each comprising:
a second transceiver for receiving the wireless digital audio signals from the signal broadcasting circuit;
a digital to analog converter for converting the digital audio signals into analog audio signals;
an amplifier for amplifying the analog audio signals; and
a speaker for converting the amplified analog audio signals into sound.
